(19) United States
(12) Patent Application Publication
(10) Pub. No.: US 2004/0035031 A1
(43) Pub. Date: Feb. 26, 2004

(54) Light apparatus including light emitting diodes

(75) Inventors: Richard Pinter, Pleasant Prairie, WI (US); Robert Chich, Mequon, WI (US)

Correspondence Address: Daniel S. Jones, Michael Best & Friedrich LLP, 100 East Wisconsin Avenue, Milwaukee, WI, 53202-4108, US

(73) Assignee: Midwest Controls, Pleasant Prairie, WI

(21) Appl. No.: 10/223,777

(22) Filed: Aug. 20, 2002

(51) Int. Cl. G09F 13/22

(52) U.S. Cl. 40/454; 40/544

(57) ABSTRACT

A light apparatus includes a plurality of light emitting diodes and a lenticular lens having a plurality of spaced apart ridges for stretching light emitted by the plurality of light emitting diodes. The light apparatus may include a controller for activating and deactivating the light emitting diodes in a sequence and the controller may include a user interface for programming the sequence.

### BACKGROUND OF THE INVENTION

The invention relates to a light apparatus using light emitting diodes (LEDs). More specifically, the invention relates to an apparatus and a method for lighting light emitting diodes and for stretching the light emitted by the light emitting diodes with a lenticular lens.

### SUMMARY OF THE INVENTION

The present invention provides a light apparatus including a plurality of light emitting diodes and a lenticular lens having a plurality of spaced apart ridges for stretching light emitted by the plurality of light emitting diodes. The light apparatus may include a controller for activating and deactivating the plurality of light emitting diodes in a selected sequence, and the controller may be programmable to activate and deactivate the plurality of light emitting diodes in first and second separate sequences. The light apparatus may include a user interface for programming the controller.

The plurality of light emitting diodes may include a first light emitting diode having a first color and a second light emitting diode having a second different color. The lens may be cylindrical, flat, or substantially any other shape.

The plurality of spaced apart ridges may be substantially parallel to each other and the plurality of light emitting diodes may be arranged perpendicularly or parallel to the ridges. The light apparatus may include a housing substantially enclosing the plurality of light emitting diodes and supporting the lens.

Other features and advantages of the invention will become apparent to those skilled in the art upon review of the following detailed description, claims, and drawings.

### BRIEF DESCRIPTION OF THE DRAWINGS

The present invention is further described with reference to the accompanying drawings, which show preferred embodiments of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

FIG. 1 is a cut-away perspective view of a light apparatus embodying the invention.

FIG. 2 is a cross-section view taken along line 2-2 in FIG. 1.

FIG. 3 is a diagrammatic representation of the light pathway in the light apparatus.

FIG. 3a is an enlarged front view of the portion of the light apparatus shown in FIG. 3.

FIG. 4 is a perspective cut-away view of an alternative light apparatus embodying the invention.

FIG. 5 is a perspective view of a second alternative light apparatus embodying the invention.

FIG. 5a is a cross-section view of the light apparatus taken along 5a-5a in FIG. 5.

### DETAILED DESCRIPTION

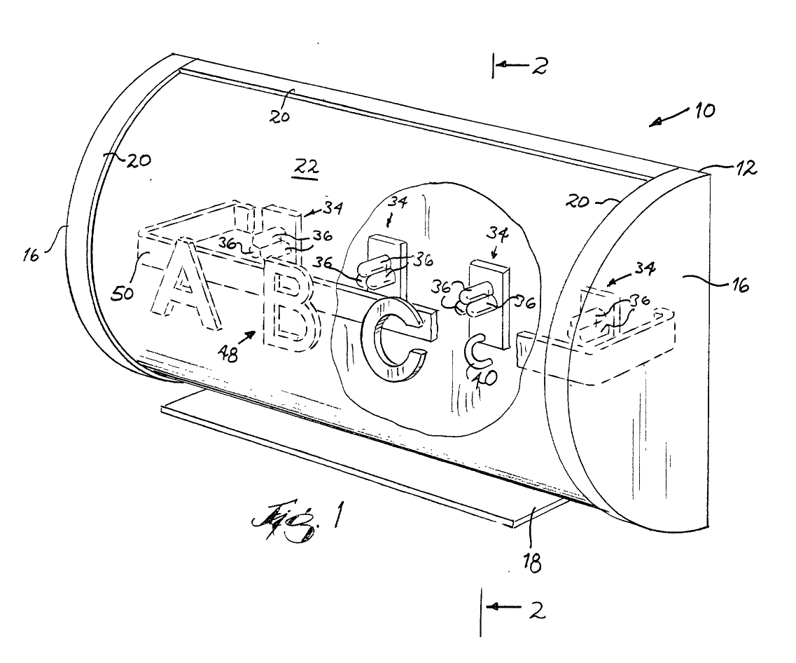

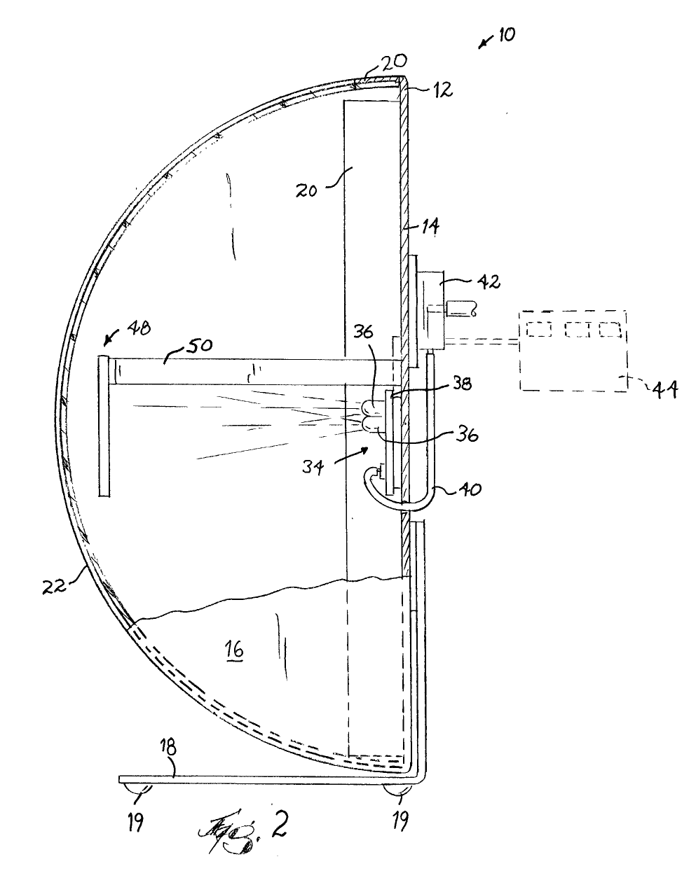

FIGS. 1 and 2 illustrate a light apparatus 10 for use in point-of-purchase displays to attract purchasers' attention to the display. The light apparatus 10 includes a housing 12 having a back wall 14, sides 16, and a base 18 located on its bottom to stabilize the light apparatus 10 while the light apparatus 10 is resting on a generally flat surface. The inner surface of the back wall 14 is uniformly colored with a semi-reflective material or a holographic film to reflect light outwardly. The base 18 includes integrally formed feet 19 located on its bottom to further stabilize the light apparatus 10.

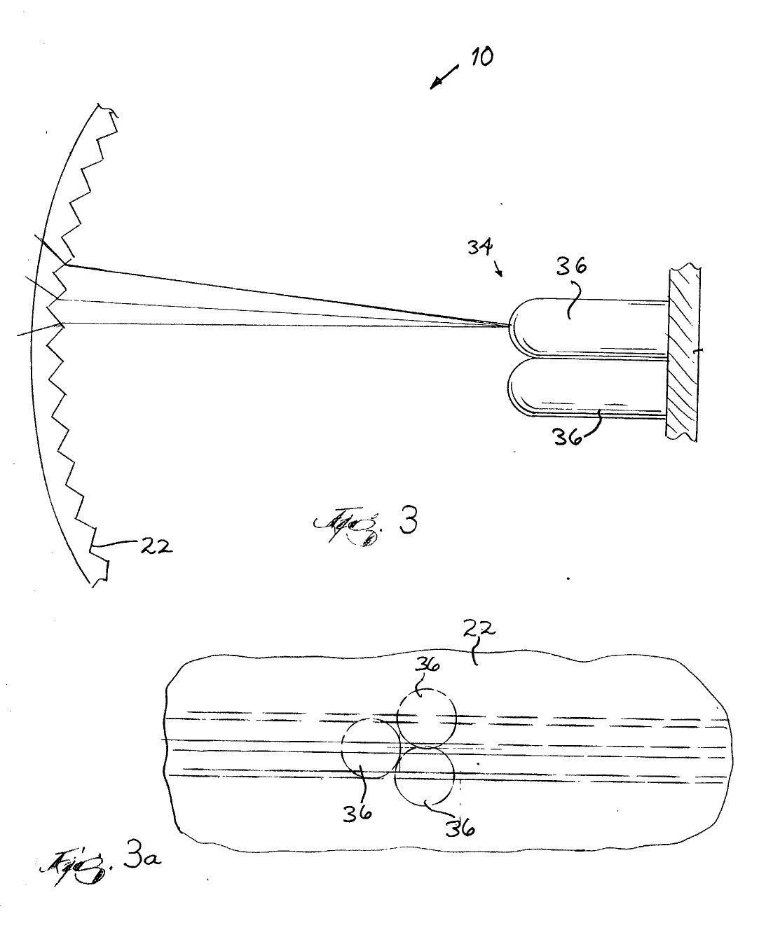

With reference to FIGS. 1-3, edges or a frame 20 extends outwardly from the back wall 14, the sides 16, and the base 18 and support a lens 22. The lens 22 is transparent or translucent so that light can pass from the interior of the light apparatus 10 through the lens 22. The lens 22 is made from a lenticular material (e.g., having ridges 24, as shown in the figures). As used herein the term “lenticular” is intended to include any material having ridges or recesses for altering the passage of light by reflection, refraction, absorption, and combinations thereof. Preferably, the lenticular material has a density of approximately 75 ridges 24 per inch. However, one having ordinary skill in the art will appreciate that in other embodiments the material may alternatively have other densities, such as, for example, 10 ridges 24 per inch. As shown in FIG. 3, the ridges 24 extend inwardly from the lens 22 into the interior of the light apparatus 10 and define raised portions and recessed portions.

As shown in FIGS. 1 and 2, the back wall 14 supports lamps 34. In the illustrated embodiment, four lamps 34 are mounted on the back wall 14. The lamps 34 include light emitting diodes (“LEDs”) 36 extending outwardly from support brackets 38 toward the lens 22. In this manner, light emitted by the LEDs 36 travels toward and through the lens 22. The LEDs 36 are preferably differently colored but may alternatively be a single uniform color or the LEDs 36 may generate white light.

With reference to FIG. 3, some of the light emitted by the LEDs 36 travels directly through the lens 22 between the ridges 24 while the majority of the light is refracted and stretched by the ridges 24 before exiting the light apparatus 10. More specifically, as light passes through the lens 22, the ridges 24 prevent at least some of the bands of light from passing unimpeded through the lens 22. The ridges 24 stretch or bend these bands of light so that parallel bands of light do not pass through the lens 22. In this manner, the relatively linear light rays emitted by the LEDs 36 are stretched into broad bands of light, forming an aesthetically pleasing light pattern.

Electrical wires 40 connect the lamps 34 and the individual LEDs 36 to a controller 42 and a power source (not shown), such as for example, a wall socket or batteries. The controller 42 is a programmable microprocessor that coordinates operation of the LEDs 36 and choreographs lighting of the LEDs 36 to produce attractive light displays by activating and deactivating the LEDs 36. In operation, the light apparatus 10 is positioned near a product and the controller 42 is programmed to choreograph selective activation of the LEDs 36, thereby generating attractive and unique lighting displays and causing passersby to notice the product. With respect to FIG. 2, the light apparatus 10 may also include a user interface 44 to permit programming of the controller 42 or to permit the selection of a light choreography from several choreographies stored in the controller 42.

A bracket 50 is mounted on the back wall 14 and extends outwardly toward the lens 22. The bracket 50 supports a sign 48 positioned on the interior side of the lens 22. In the illustrated embodiment, the sign 48 is semi-transparent and light emitted by the LEDs 36 travels through the sign 48, illuminating the sign 48. The so-illuminated sign 48 shines through the lens 22, and the light from the illuminated sign 48 is bent in an aesthetically pleasing way. In various applications, the sign 48 can include a product or company name, a slogan, and the like.

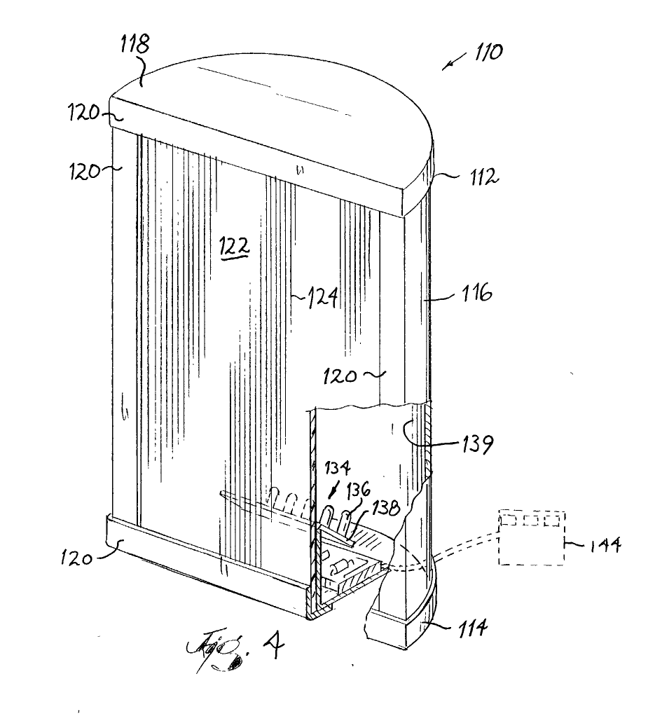

FIG. 4 illustrates a second embodiment of the present invention including a light apparatus 110 having a housing 112. The housing 112 includes a base 114, an arcuate back wall 116, and a top 118 defining edges 120. The edges 120 support a lens 122 made from a lenticular material (e.g., having ridges 124, as shown in the figures). The ridges 124 extend horizontally along the interior surface of the lens 122 from the top 118 to the base 114.

The base 114 supports a lamp 134 having a number of LEDs 136 mounted on a support bracket 138. In the illustrated embodiment, the lamp 134 is angled with respect to the base 118 to direct light emitted by the LEDs 136 toward the upper portion of the back wall 114. However, in other embodiments, the lamp 134 may be arranged differently with respect to the base 118 to create different displays. In the illustrated embodiment, the back wall 114 includes a multi-colored, multi-faceted reflective surface 139 that reflects and scatters light emitted by the LEDs 136, forming a holograph. The lens 122 bends the light emitted by the LEDs 136 and bends the holograph, forming an aesthetically pleasing display.

Some of the light emitted by the LEDs 136 travels directly through the lens 122 between the ridges 125 while the majority of the light is reflected off and is stretched by the ridges 124 before exiting the light apparatus 110. In this manner, the ridges 124 prevent parallel bands of light from passing unimpeded through the lens 122. Rather, the ridges 124 stretch or bend at least some of the bands of light emitted by the LEDs 136, forming attractive and aesthetically pleasing displays.

Electric wires 140 connect the LEDs 136 to a controller 142 and a power source (not shown). The controller 142 is a programmable microprocessor that coordinates operation of the LEDs 136 to produce aesthetically pleasing light displays by activating and deactivating the LEDs 136. As shown in FIG. 4, the light apparatus 110 may also include a user interface 144 to permit programming of the controller 142 or to permit the selection of a light choreography from several choreographies stored in the controller 142.

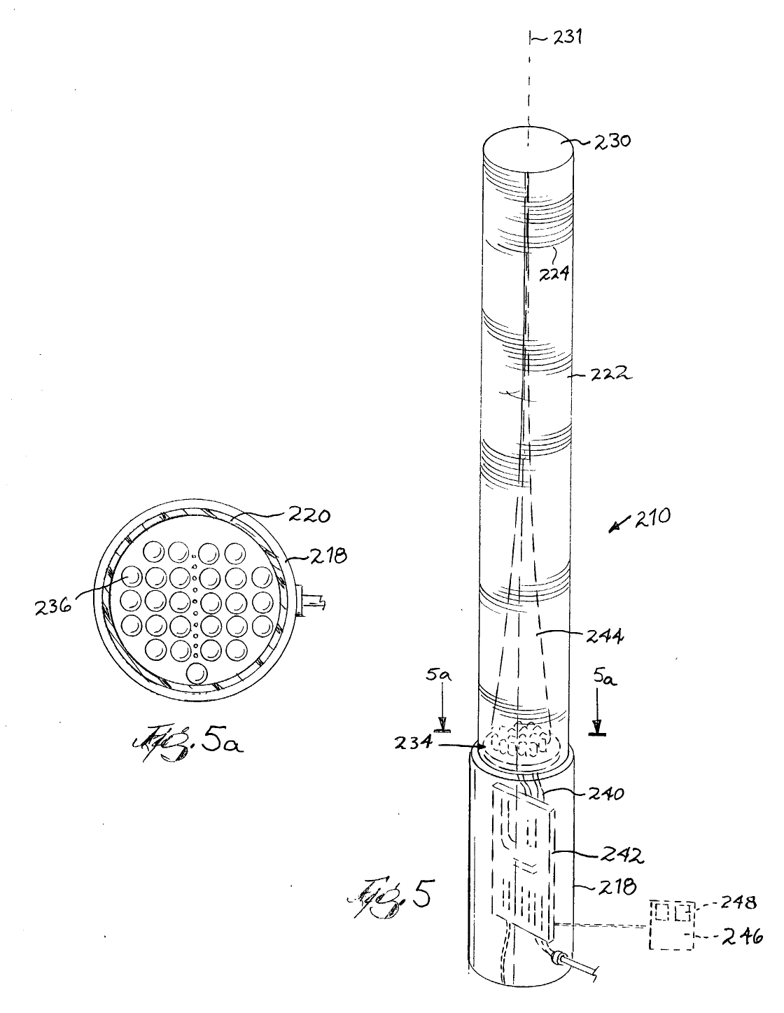

FIGS. 5 and 5a illustrate a third embodiment of the present invention including a light apparatus 210 having a cylindrical base 218 supporting a cylindrical lens 222 and a top 230. The lens 222 is made of a lenticular material (e.g., having ridges 224 extending circumferentially around the interior of the lens 222). An axis 231 extends longitudinally through the light apparatus 210 between the base 218 and the top 230. The base 218 includes a lamp 234 having a number of LEDs 236 extending upwardly toward the top 230.

Electrical wires 240 connect the LEDs 236 to a controller 242, which selectively activates the LEDs 236. Some of the light emitted by the LEDs 236 travels directly through the lens 222 between the ridges 225 while the majority of the light is reflected off and is stretched by the ridges 224 before exiting the light apparatus 210. In this manner, the ridges 224 prevent parallel bands of light from passing unimpeded through the lens 122. Rather, the ridges 224 stretch or bend some of the bands of light emitted by the LEDs 236, creating an elongated or stretched generally conical light display 244 as seen in broken lines in FIG. 5. The generally conical display 244 converges on the axis 231 over the height of the lens 222. By selectively activating and deactivating some or all of the LEDs 236, the controller 242 alters the shape (e.g., the width), size (e.g., the cone volume), color, and location (e.g., the position of the cone with respect to the axis 231) of the conical light display 244. A manual interface 246 is connected to the controller 242 and allows the user to alter (e.g., change the programmed sequence and speed of sequence execution) the light display 244. Additionally, using buttons, switches, or knobs 248 located on the controller 242, the user can select preprogrammed lighting sequences and light displays. Various features of the invention are set forth in the following claims.

What is claimed is:

1. A light apparatus comprising:
a plurality of light emitting diodes; and
a lenticular lens having a plurality of spaced apart ridges for stretching light emitted by the plurality of light emitting diodes.

2. The light apparatus of claim 1, further comprising a controller for activating and deactivating the plurality of light emitting diodes in a random and programmed sequence.

3. The light apparatus of claim 2, further comprising a user interface for programming the controller.

4. The light apparatus of claim 2, wherein the controller is programmable to activate and deactivate the plurality of light emitting diodes in first and second separate sequences.

5. The light apparatus of claim 2, wherein the plurality of light emitting diodes include a first light emitting diode of a first color and a second light emitting diode of a second different color, and wherein the controller activates the first light emitting diode and the second light emitting diode in a selected sequence.

6. The light apparatus of claim 1, wherein the plurality of light emitting diodes include a first light emitting diode of a first color and a second light emitting diode of a second different color.

7. The light apparatus of claim 1, wherein the lens is generally cylindrical.

8. The light apparatus of claim 1, wherein the lens has a cylinder axis and wherein the ridges extend perpendicular to the cylinder axis.

9. The light apparatus of claim 1, wherein the plurality of light emitting diodes emit light in a direction substantially perpendicular to the ridges.

10. The light apparatus of claim 1, wherein the lens has a cylinder axis and wherein the ridges extend parallel to the cylinder axis.

11. The light apparatus of claim 1, further comprising a housing substantially enclosing the plurality of light emitting diodes and supporting the lens.

12. The light apparatus of claim 11, wherein the lens is generally cylindrical and supported at a first end by the housing such that the light emitting diodes emit light into the first end of the cylindrical lens and further comprising a cap covering a second opposite end of the cylindrical lens.

13. The light apparatus of claim 1, wherein the lens is arcuate.

14. A light apparatus comprising:
a plurality of differently colored light emitting diodes;
a controller in electrical communication with the plurality of light emitting diodes for choreographing lighting of the plurality of differently colored light emitting diodes; and
a lenticular lens at least partially enclosing the plurality of light emitting diodes, the lenticular lens having a plurality of spaced apart ridges for stretching light emitted by the light emitting diodes.

15. The light apparatus of claim 14, wherein the controller alternately activates and deactivates selected ones of the plurality of light emitting diodes in a selected sequence.

16. The light apparatus of claim 14, further comprising a user interface for programming the choreography of the controller.

17. The light apparatus of claim 14, wherein the plurality of light emitting diodes include a first light emitting diode of a first color and a second light emitting diode of a second different color.

18. The light apparatus of claim 14, wherein the lens is generally cylindrical.

19. The light apparatus of claim 18, wherein the lens has a cylinder axis and wherein the ridges extend perpendicular to the cylinder axis.

20. The light apparatus of claim 14, wherein the light emitting diodes emit light in a direction substantially perpendicular to the ridges.

21. The light apparatus of claim 14, further comprising a housing substantially enclosing the plurality of light emitting diodes and supporting the lens.

22. The light apparatus of claim 21, wherein the lens is generally cylindrical and supported at a first end by the housing such that the light emitting diodes emit light into the first end of the cylindrical lens and further comprising a cap covering a second opposite end of the cylindrical lens.

23. The light apparatus of claim 14, wherein the lens is arcuate.

24. A method of providing illumination with a light apparatus, the light apparatus including at least one light emitting diode and a lenticular lens at least partially surrounding the light emitting diode, the method comprising:
generating light with the light emitting diode;
directing the light from light emitting diode through the lenticular lens; and
stretching the light with the lenticular lens.

25. The method of claim 24, wherein the at least one light emitting diode includes a plurality of light emmitting diodes, wherein the light apparatus includes a controller, and wherein the plurality of light emitting diodes includes a first light emitting diode and a second light emitting diode, the method further comprising choreographing lighting of the first light emitting diode and the second light emitting diode.

26. The method of claim 24, further comprising forming the lens into a cylindrical shape.

27. The method of claim 24, further comprising forming the lens into a cylindrical shape and emitting light with the at least one light emitting diode into a first end of the cylindrical lens.

28. The method of claim 27, further comprising capping a second, opposite end of the cylindrical lens.
